(19) United States
(12) Patent Application Publication
(10) Pub. No.: US 2022/0390818 A1
(43) Pub. Date: Dec. 8, 2022

(54) SYSTEM FOR PROCESSING AND PROJECTING LIGHT FROM LIGHT SOURCE AND PROJECTION DEVICE

(71) Applicants: HONG FU TAI PRECISION ELECTRONS (YANTAI) CO., LTD., Yantai (CN); HON HAI PRECISION INDUSTRY CO., LTD., New Taipei (TW)

(72) Inventors: SHI-KAI HUANG, New Taipei (TW); TSUNG-JE CHIU, New Taipei (TW)

(21) Appl. No.: 17/674,078

(22) Filed: Feb. 17, 2022

(30) Foreign Application Priority Data
Jun. 2, 2021 (CN) 202110615837.7

(51) Int. Cl. G03B 21/20; G02B 26/00

(52) U.S. Cl. CPC G03B 21/204; G02B 26/008; G03B 21/2066; G03B 21/208

(57) ABSTRACT

A projection light source system includes a laser light source, a fluorescence wheel, a color wheel, and a light guide assembly. The fluorescence wheel includes a yellow fluorescence area, a green fluorescence area, and a blue fluorescence area. The yellow fluorescence area, the green fluorescence area, and the blue fluorescence area are configured to receive excitation light in time sharing, and generate fluorescence of different colors according to the excitation light. The yellow fluorescence area is configured to generate yellow fluorescence, the green fluorescence area is configured to generate green fluorescence, and the blue fluorescence area is configured to generate blue fluorescence. The color wheel is configured to receive the fluorescence and output red light, green light, and blue light in sequence to form light in three basic colors. The light guide assembly is located on a light path of the excitation light and the fluorescence.

### TECHNICAL FIELD

The present disclosure relates to the technical field of lighting, and in particular to a projection laser source system and a projection device.

### BACKGROUND

Laser light source has advantages of good monochromaticity, strong directivity, and high brightness. In recent years, it has been widely used in the field of projection display. “Primary color” refers to an elemental “basic color” that cannot be obtained by mixing other colors. Human naked eyes have pyramidal cells that perceive three different colors: red, green, and blue, and a color space is usually expressed by mixing three basic colors. In the field of projection technology, light is excited to irradiate a fluorescing wheel to obtain a received laser, the received laser and the excited light are combined, and then the three primary colors are obtained after color wheel filtering, and the function of uniform laser light source illumination is achieved.

In the process of outputting three primary colors, the existing laser projection light source system needs to collect the excited light and the received laser respectively, and the excited light and the received laser are combined after being transmitted from different optical paths. That is, two different optical paths need to be set, which requires additional optical element cost, and the layout process is complex.

Therefore, improvement is desired.

### BRIEF DESCRIPTION OF THE DRAWINGS

FIG. 1 is a schematic diagram of a light projection device according to an embodiment of the present disclosure.

FIG. 2 is a schematic diagram of a light source system for projection according to an embodiment of the present disclosure.

FIG. 3 is schematic diagram of a fluorescence wheel of an embodiment of the present disclosure.

FIG. 4 is a schematic diagram of a color wheel of an embodiment of the present disclosure.

### DETAILED DESCRIPTION

The technical solutions in the embodiments of the present disclosure will be described in conjunction with the accompanying drawings in the embodiments of the present disclosure. Obviously, the described embodiments are some embodiments of the present disclosure, not all of them. Based on the embodiments of the present disclosure, all other embodiments obtained by those of ordinary skill in the art without creative work shall fall within the protection scope of the present disclosure.

The following disclosure provides many different embodiments or examples to implement different structures of the present application. In order to simplify the disclosure of the present application, the components and settings of specific examples are described below. Of course, they are merely examples and are not intended to limit the present application. In addition, the present application may repeat reference numbers and reference letters in different examples for the purpose of simplification and clarity, which itself does not indicate the relationship between the various embodiments and settings discussed.

Some embodiments of the present disclosure are described in detail below in combination with the accompanying drawings.

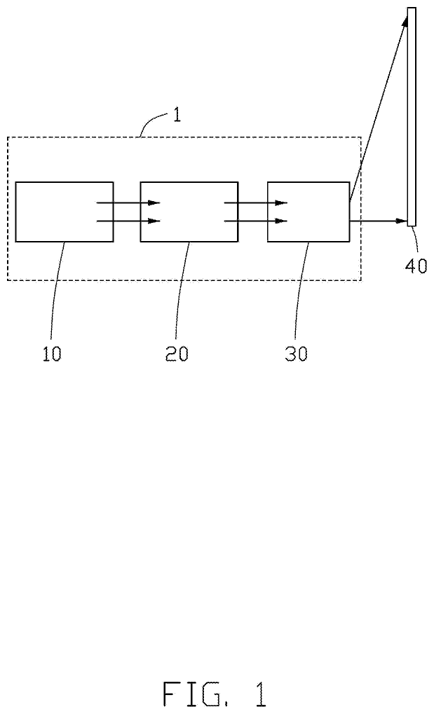

FIG. 1 illustrates a light projection device 1 in accordance with an embodiment of the present disclosure. The light projection device 1 includes a projection light source system 10, a light modulator 20, and a projection lens 30. The projection light source system 10, the light modulator 20, and the projection lens 30 are arranged in sequence along the beam transmission direction. The projection light source system 10 is used to emit light from a light source, the light modulator 20 is used to modulate the light into an image for projection, and the projection lens 30 is used to project the image onto a projection screen 40.

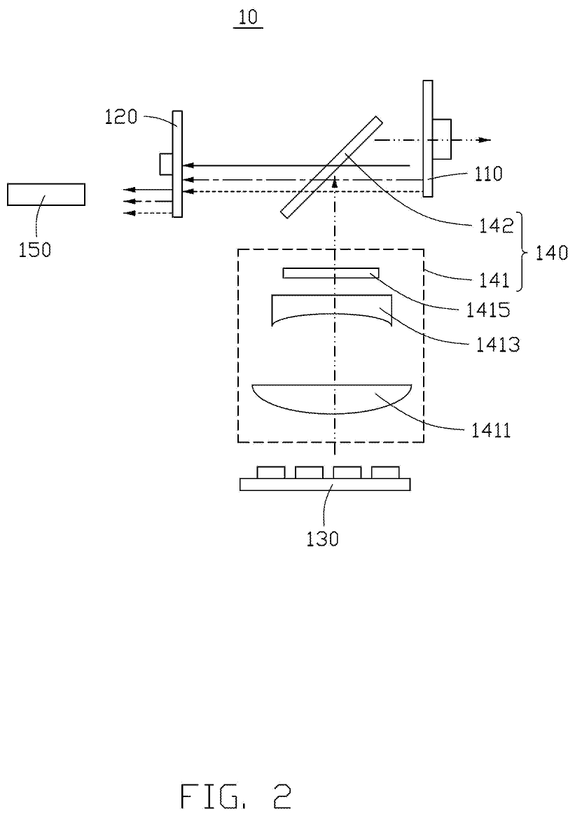

Referring to FIG. 2, the projection light source system 10 includes a fluorescence wheel 110, a color wheel 120, a laser light source 130, and a light guide assembly 140. The laser light source 130 is used for emitting light of at least one color which is excited. It can be understood that the laser light source 130 can be a monochromatic laser light source, that is, it includes a laser, and the laser emits light of one color. The laser light source 130 may also be a hybrid laser light source, that is, it includes a plurality of lasers, each laser emitting light of different colors, and the plurality of lasers is used to emit light of multiple colors. The light emitted by the laser light source 130 is visible light with a wavelength less than that of blue light, such as purple light, and the light is coherent and parallel light. In the embodiment, the laser light source 130 is used to emit a purple laser.

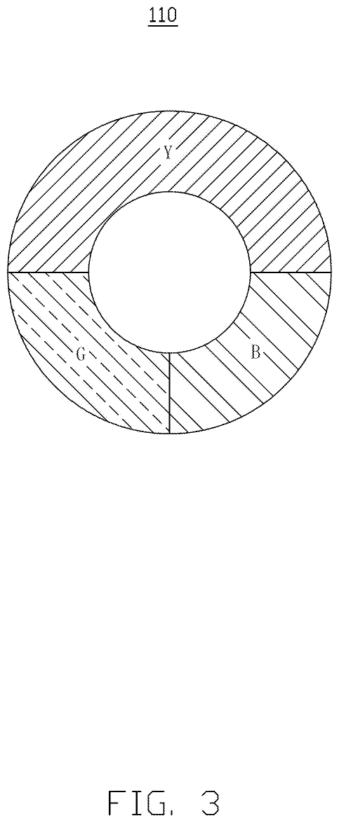

Referring to FIG. 3, the fluorescence wheel 110 includes a yellow fluorescence area Y, a green fluorescence area G, and a blue fluorescence area B. The fluorescence areas receive the light, and are stimulated to emit light, that is, yellow fluorescence from the yellow fluorescence area Y, green fluorescence from the green fluorescence area G, and blue fluorescence from the blue fluorescence area B.

The fluorescence wheel 110 is arranged in an emission path of the light emitted by the laser light source 130. The fluorescence wheel 110 is used to generate different colors of fluorescence according to the light received. The fluorescence includes yellow fluorescence, green fluorescence, and blue fluorescence. The color wheel 120 is arranged in a path of the light output from the fluorescence wheel 110. The color wheel 120 includes a red color segment, a green color segment, and a blue color segment, all receiving the fluorescence emitted by the fluorescence wheel 110 and outputting red light, green light, and blue light in sequence to form three basic colors of light.

The light guide assembly 140 is arranged on an optical path of the light emitted by the laser light source 130 and the fluorescence emitted by the fluorescence wheel 110. The light guide assembly 140 is used to guide purple excitation light emitted by the laser light source 130 to the fluorescence wheel 110, and to guide the fluorescence emitted by the fluorescence wheel 110 to be emitted after being filtered by the color wheel 120. The light source is used for projecting and displaying an image.

In the embodiment, the light guide assembly 140 includes a beam shaping component 141 and a light combining component 142. The beam shaping component 141 is located on an outgoing light path of purple source light, and compresses the light to reduce the area of its beam. The compressed light is still parallel light, and the shaped laser light is forwarded to the light combining component 142. The beam shaping component 141 can improve the transmittance in the optical devices (such as the light combining component 142, the fluorescence wheel 110, the color wheel 120, and the light collecting part 150) along the optical path. For example, the beam shaping component 141 may include a convex lens 1411, a concave lens 1413, and a diffuser 1415. The convex lens 1411 is used to converge light, the concave lens 1413 is used to diverge light, and the diffuser 1415 is used to reduce the power density of the focused laser on the fluorescence wheel 110 to improve the luminous efficiency of phosphor. The light combining component 142 is used to transmit the received light to the fluorescence wheel 110, and the light combining component 142 is also used to transmit the fluorescence emitted by the fluorescence wheel 110 to the color wheel 120. The fluorescence is the fluorescence emitted by the fluorescence areas after irradiation of the fluorescence areas. For example, the light combining component 142 may include a light combining dichroic sheet.

The projection light source system 10 according to the embodiment of the present disclosure is set in the light path and the structure of the fluorescence wheel 110, so that in the process of generating the three primary colors of light, the blue primary color light is directly generated by the fluorescence wheel 110 without requiring collection of light along two different paths to collect the blue light, red light, and green light separately. On the one hand, it simplifies the complexity of the projection light source system, reduces the number of optical elements required, and reduces the manufacturing and use cost. On the other hand, the reduction of optical elements and the simplification of optical path reduces the complexity of electronic software control, so as to improve the use efficiency of projection and the quality of picture projected.

The fluorescence wheel 110 and the color wheel 120 do not need to set a light transmission area, so as to reduce processing and manufacturing steps and complexity, and the cost.

More importantly, the fluorescence wheel 110 directly provides trichromatic light so that the trichromatic light is fluorescence, so that when the trichromatic light enters the projection equipment, it is not necessary to modulate two different types of light (the source light and fluorescence), and the steps, complexity, and calculation difficulty when the projection equipment modulates the trichromatic light into a beam for projection are simplified.

The simplification of the primary color light path reduces the loss of the primary color light, and then reduces the loss in brightness of a projected picture, promoting a high-quality display of the projected picture.

In the embodiment, the total number of the yellow fluorescence area Y, the green fluorescence area G, and the blue fluorescence area B is defined as m, 3≤m≤6, and m is an integer. The color of the light emitted from adjacent fluorescence areas is different. The fluorescence wheel 110 may include one yellow fluorescence area Y, one green fluorescence area G, and one blue fluorescence area B. The fluorescence wheel 110 may also include two yellow fluorescence areas Y, one green fluorescence area G, and one blue fluorescence area B. Similarly, the fluorescence wheel 110 may include one yellow fluorescence area Y, two green fluorescence areas G, and one blue fluorescence area B. The fluorescence wheel 110 may also include one yellow fluorescence area Y, one green fluorescence area G, and two blue fluorescence areas B. The fluorescence wheel 110 may also include two yellow fluorescence areas Y, two green fluorescence areas G, and one blue fluorescence area B. Similarly, the fluorescence wheel 110 may include two yellow fluorescence areas Y, one green fluorescence area G, and two blue fluorescence areas B. The fluorescence wheel 110 may also include one yellow fluorescence area Y, two green fluorescence areas G, and two blue fluorescence areas B. The fluorescence wheel 110 may also include two of each fluorescence area Y, G, and B.

The fluorescence wheel 110 includes a substrate (not shown). The yellow fluorescence area Y, the green fluorescence area G, and the blue fluorescence area B of the fluorescence wheel 110 can be arranged circumferentially on the substrate. Referring to FIG. 3, a yellow phosphor (not shown), a green phosphor (not shown), and a blue phosphor (not shown) are arranged on the substrate of the fluorescence wheel 110, to form the yellow fluorescence area Y, the green fluorescence area G, and the blue fluorescence area B respectively. Each fluorescence area can emit light of the required color by irradiating and exciting the phosphor of the corresponding color. For example, the colors of the light emitted from the fluorescence areas include yellow, green, and blue. FIG. 3 illustrates that the substrate has a yellow fluorescence area Y, a green fluorescence area G, and a blue fluorescence area B as an example.

In the embodiment, when the fluorescence wheel 110 is in the working state, the fluorescence wheel 110 rotates at a uniform speed around the center in a clockwise or counterclockwise direction so that the yellow fluorescence area Y, the green fluorescence area G, and the blue fluorescence area B are periodically located on the emission path of the source light. When the purple light is incident to the yellow fluorescence area Y, the fluorescence wheel 110 emits the yellow fluorescence, when the purple light is incident to the green fluorescence area G, the fluorescence wheel 110 emits the green fluorescence, and when the purple light is incident to the blue fluorescence area B, the fluorescence wheel 110 emits the blue fluorescence.

Therefore, the yellow fluorescence area Y, the green fluorescence area G, and the blue fluorescence area B emit fluorescence in different colors. With the periodic rotation of the fluorescence wheel 110, the yellow fluorescence area Y, the green fluorescence area G and the blue fluorescence area B are periodically located on the emission path of the source light. The fluorescence wheel 110 will periodically emit the yellow light, the green light, and the blue light.

Alternatively, the shape of each fluorescence area of the fluorescence wheel 110 may be fan-shaped, and the size of the area of each fluorescence area, that is, the size of the circumferential angle of each fluorescence area, that is, the light intensity of the outputted beam, may be set according to the actual situation.

In the embodiment, the total number of the above red color segment R, green color segment G, and blue color segment B is defined as n, 3≤n≤6, and n is an integer. The light emitted from the color wheel 120 has at least three colors, and the color of the light filtered by each adjacent color segment of the color wheel 120 is different. For example, the incident light of the color wheel 120 is yellow light (corresponding to the red color segment R), green light (corresponding to the green color segment G), and blue light (corresponding to the blue color segment B), and the emitted light is the red light (corresponding to the red color segment R), the green light (corresponding to the green color segment G), and the blue light (corresponding to the blue color segment B).

The color wheel 120 may include a single red color segment R, a single green color segment G, and a single blue color segment B. The color wheel 120 may also include two red color segments R, one green color segment G, and one blue color segment B. Similarly, the color wheel 120 may include one red color segment R, two green color segments G, and one blue color segment B. The color wheel 120 may also include one red color segment R, one green color segment G, and two blue color segments B. The color wheel 120 may also include two red color segments R, two green color segments G, and one blue color segment B. The color wheel 120 may also include two red color segments R, one green color segment G, and two blue color segments B. The color wheel 120 may also include one red color segment R, two green color segments G, and two blue color segments B. The color wheel 120 may also include two of each of the red color segment R, the green color segment G, and the blue color segment B.

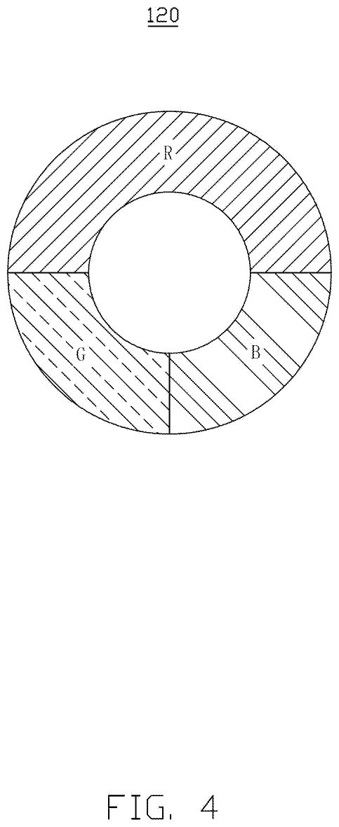

Referring to FIG. 4, the color wheel 120 includes a substrate (not shown). The red color segment R, the green color segment G, and the blue color segment B of the color wheel 120 can be arranged circumferentially on the substrate. The substrate of the color wheel 120 is provided with the red dye (not shown), the green dye (not shown), and the blue dye (not shown), this absorbs all light other than the color of the dye. That is, the red color segment R can only emit red light, the green color segment G can only emit green light, and the blue color segment B can only emit blue light. FIG. 4 illustrates that the substrate of the color wheel 120 has a red color segment R, a green color segment G, and a blue color segment B.

Alternatively, the fluorescence wheel 110 and the color wheel 120 are configured to rotate synchronously. The shape of each fluorescence area of the fluorescence wheel 110 may be fan- or ring-shaped, and the size of the area of each fluorescence area, that is, the size of the circumferential angle of each fluorescence area, that is, the light intensity of the output beam, can be determined according to the actual situation.

In the embodiment, when the color wheel 120 is in the working state, it rotates at a uniform speed in a clockwise or counterclockwise direction, so that the red color segment R, the green color segment G, and the blue color segment B are periodically located on the emission path of fluorescence. Since the fluorescence wheel 110 and the color wheel 120 are configured to rotate synchronously, the red color segment R of the color wheel 120 corresponds to the yellow fluorescence area Y of the fluorescence wheel 110, the green color segment G of the color wheel 120 corresponds to the green fluorescence area G of the fluorescence wheel 110, and the blue color segment B of the color wheel 120 corresponds to the blue fluorescence area B of the fluorescence wheel 110. When the fluorescence wheel 110 emits the yellow fluorescence, the yellow fluorescence is filtered out after passing through the red color segment R of the color wheel 120, so that the color wheel 120 emits red light. When the fluorescence wheel 110 emits the green fluorescence, the green fluorescence passes through the green color segment G of the color wheel 120, so that the color wheel 120 emits green light. When the fluorescence wheel 110 emits the blue fluorescence, the blue fluorescence passes through the blue color segment B of the color wheel 120, so that the color wheel 120 emits blue light, so that the laser projection system disclosed effectively emits light of base colors. The red color segment R, the green color segment G, and the blue color segment B emit primary colors of light in those colors. With the periodic rotation of the color wheel 120, the red color segment R, the green color segment G, and the blue color segment B are periodically located on the emission path of the fluorescence, and the color wheel 120 periodically emits red, green, and blue light.

Since a plurality of the color segments of the color wheel 120 corresponds to a plurality of the fluorescence areas of the fluorescence wheel 110, when the arrangement order of areas of the fluorescence wheel 110 is changed, the arrangement order of the color segments of the color wheel 120 is also changed.

Referring to FIG. 2, the projection light source system 10 also includes a light collecting part 150. The light collecting part 150 homogenizes the red light, the green light, and the blue light emitted by the color wheel 120, so as to provide an output of a uniform light beam. The light collecting part 150 may include a light rod.

The light output process of the projection light source system 10 includes: the laser light source 130 emits purple light, the purple light beam is compressed and shaped by the beam shaping component 141, emitted on to the light combining component 142, and then transmitted to the fluorescence wheel 110. The fluorescence wheel 110 rotates. When the purple light irradiates the fluorescence wheel 110, the phosphors (not shown) in the fluorescence areas are excited and each emit fluorescence of at least one color (such as the yellow fluorescence, the green fluorescence, or the blue fluorescence). The plurality of the fluorescence areas of the fluorescence wheel 110 emits the yellow fluorescence, the green fluorescence, and the blue fluorescence to the light combining component 142 in a sequential manner. After the yellow fluorescence, the green fluorescence, and the blue fluorescence pass through the light combining component 142 and enter the color wheel 120, the yellow fluorescence is filtered into red light, and the green fluorescence and the blue fluorescence in unchanged colors are emitted from the color wheel 120. The color wheel 120 emits the red light, the green light, and the blue light into the light collecting part 150.

Those of ordinary skill in the art should realize that the above embodiments are only used to illustrate the present disclosure, but not to limit the present disclosure. As long as they are within the essential spirit of the present disclosure, the above embodiments are appropriately made. Changes and changes fall within the scope of protection of the present disclosure.

What is claimed is:

1. A projection light source system comprising:
a laser light source emitting excitation light;
a fluorescence wheel comprising a yellow fluorescence area, a green fluorescence area, and a blue fluorescence area; wherein the yellow fluorescence area, the green fluorescence area, and the blue fluorescence area are configured to receive the excitation light in time sharing, and generate fluorescence of different colors according to the excitation light; wherein the yellow fluorescence area is configured to generate yellow fluorescence, the green fluorescence area is configured to generate green fluorescence, and the blue fluorescence area is configured to generate blue fluorescence;
a color wheel comprising a red color segment, a green color segment, and a blue color segment; wherein the color wheel is configured to receive the fluorescence emitted by the fluorescence wheel and output red light, green light, and blue light in sequence to form light in three basic colors;
a light guide assembly locating on a light path of the excitation light and the fluorescence; wherein the light guide assembly is configured to guide the excitation light to the fluorescence wheel and guide the fluorescence to be filtered by the color wheel and emitted as light source light.

2. The projection light source system of claim 1, wherein:
the fluorescence wheel and the color wheel are configured to rotate synchronously.

3. The projection light source system of claim 2, wherein:
the fluorescence wheel and the color wheel rotate synchronously, and each of the red color segment, the green color segment, and the blue color segment is periodically located on an emission path of the fluorescence emitted by the fluorescence wheel.

4. The projection light source system of claim 1, wherein:
the excitation light is visible light with a wavelength less than the blue light.

5. The projection light source system of claim 1, wherein:
the excitation light is parallel light.

6. The projection light source system of claim 1, wherein:
the yellow fluorescence area, the green fluorescence area, and the blue fluorescence area are fan-shaped or fan-shaped ring respectively.

7. The projection light source system of claim 1, wherein:
the red color segment, the green color segment, and the blue color segment are fan-shaped or fan-shaped ring respectively.

8. The projection light source system of claim 1, further comprising a light collecting part homogenizing the red light, the green light, and the blue light output from the color wheel.

9. The projection light source system of claim 1, wherein:
the light guide assembly comprises a beam shaping component compressing the excitation light emitted by the laser light source, to reduce an area of the excitation light.

10. The projection light source system of claim 9, wherein:
the beam shaping component comprises a convex lens, a concave lens, and a diffuser, the convex lens is configured to converge light, the concave lens is configured to diverge the light, and the diffuser is configured to reduce laser focus power density on the fluorescence wheel.

11. A light projection device comprising:
a projection light source system configured for emitting light source light and comprising:
a laser light source emitting excitation light;
a fluorescence wheel comprising a yellow fluorescence area, a green fluorescence area, and a blue fluorescence area; wherein the yellow fluorescence area, the green fluorescence area, and the blue fluorescence area are configured to receive the excitation light in time sharing, and generate fluorescence of different colors according to the excitation light; wherein the yellow fluorescence area is configured to generate yellow fluorescence, the green fluorescence area is configured to generate green fluorescence, and the blue fluorescence area is configured to generate blue fluorescence;
a color wheel comprising a red color segment, a green color segment, and a blue color segment; wherein the color wheel is configured to receive the fluorescence emitted by the fluorescence wheel and output red light, green light, and blue light in sequence to form light in three basic colors;
a light guide assembly locating on a light path of the excitation light and the fluorescence; wherein the light guide assembly is configured to guide the excitation light to the fluorescence wheel and guide the fluorescence to be filtered by the color wheel and emitted as the light source light;
a light modulator modulating the light source light into a projection image.

12. The light projection device of claim 11, wherein:
the fluorescence wheel and the color wheel are configured to rotate synchronously.

13. The light projection device of claim 12, wherein:
the fluorescence wheel and the color wheel rotate synchronously, and each of the red color segment, the green color segment, and the blue color segment is periodically located on an emission path of the fluorescence emitted by the fluorescence wheel.

14. The light projection device of claim 11, wherein:
the excitation light is visible light with a wavelength less than the blue light.

15. The light projection device of claim 11, wherein:
the excitation light is parallel light.

16. The light projection device of claim 11, wherein:
shapes of the yellow fluorescence area, the green fluorescence area and the blue fluorescence area are fan-shaped or fan-shaped ring respectively.

17. The light projection device of claim 11, wherein:
shapes of the red color segment, the green color segment and the blue color segment are fan-shaped or fan-shaped ring respectively.

18. The light projection device of claim 11, wherein:
the projection light source system further comprises a light collecting part homogenizing the red light, the green light, and the blue light output from the color wheel.

19. The light projection device of claim 11, wherein:
the light guide assembly comprises a beam shaping component compressing the excitation light emitted by the laser light source, to reduce an area of the excitation light.

20. The light projection device of claim 19, wherein:
the beam shaping component comprises a convex lens, a concave lens, and a diffuser, the convex lens is configured to converge light, the concave lens is configured to diverge the light, and the diffuser is configured to reduce laser focus power density on the fluorescence wheel.
